(19) United States
(12) Patent Application Publication
(10) Pub. No.: US 2003/0224856 A1
(43) Pub. Date: Dec. 4, 2003

(54) Internet gaming system

(76) Inventors: Antonin Bukovsky, Knoxville, TN (US); Andrew J. Roberto, Knoxville, TN (US)

Correspondence Address: LUEDEKA, NEELY & GRAHAM, P.C., P O BOX 1871, KNOXVILLE, TN, 37901, US

(21) Appl. No.: 10/158,268

(22) Filed: May 30, 2002

(51) Int. Cl. A63F 13/00

(52) U.S. Cl. 463/42

(57) ABSTRACT

An internet gaming system that provides an improved method and apparatus for playing multi-player internet games is provided by the present invention. The gaming system allows a player to create character and select of number of the characters attributes. Multiple characters are then organized into internet teams or leagues. The attributes of the team such as its logo, colors, name, etc. are also selected by the players on the team. A team chat room is created to provide an area for team members to discuss their performance in a prior game or their strategy for an upcoming game. The gaming system then facilitates scheduling of games between teams that are registered with the game server. After a game is played, experience points are allocated to the characters based upon their performance during a game. These experience points can be spent by the players to upgrade their characters performance. To improve the flow of the game play, the amount of static information transmitted between the game server and the remote terminals is minimized.

### FIELD OF THE INVENTION

The present invention relates generally to the field of internet based video games. More particularly, the preferred embodiment of the present invention relates to an internet football league that allows participants to create players and join teams for an interactive season of internet football.

### BACKGROUND OF THE INVENTION

A variety of video games are widely available today and sales of video games are increasing every year. Many of the video games available are sport simulations that simulate popular sports such as baseball, basketball and football. Some video games even allow players to compete with one another over the internet. Unfortunately, the performance of these games is lacking in that the movement of the players is choppy and strongly depends upon the speed of the player's connection to the internet. This is due to the fact that information is regularly being sent between the game server and the remote terminals of the users playing the game. In addition, many of the sport simulation games available fail to accurately simulate the competitive atmosphere of the real life games upon which they are based. Therefore, what is needed is an improved video game that accurately simulates the competitive nature of sports and allows for smooth play over the internet.

### SUMMARY OF THE INVENTION

A preferred embodiment of the present invention is designed to address the above discussed problems with the prior art by providing an improved method of conducting a network gaming system that utilizes a plurality of remote terminals coupled to a game server. In accordance with the method, an identification code is assigned to each of a plurality of players such that each player is uniquely identified by their corresponding identification code. A game server receives the identification codes from players at the remote terminals and verifies that the received identification codes correspond to authorized identification codes. The authorized players at the remote terminals are prompted to create characters associated with the players by selecting a set of character attributes for each character. These attributes may include physical attributes such as height, weight, hair color, eye color, skin pigmentation, body type, etc., and performance attributes such as speed, strength, agility, stamina, intelligence, game perception, experience points, etc. In one embodiment of the invention, the characters are selected from a data base of famous sports personalities.

Groups of player created characters are formed into teams and games are scheduled between the teams of player created characters. The players on a team are prompted to select a set of team attributes such as the team name, logo and uniform style. Alternatively, the team attributes could be selected from a data base of professional sports teams. Once the teams are determined, the scheduled games are conducted and the results of the games are stored on the game server. A plurality of team chat rooms are formed that are accessible from the remote terminals. Each team chat room is associated with a particular team such that characters on a particular team can have a discussion with other characters on their team. A game chat room is also formed such that all players that have a character involved in a game can discuss the game.

The scheduled games are conducted by establishing a set of data that represents a game server virtual playing field on the game server. The characters are positioned on the game server virtual playing field and the game server virtual playing field data is downloaded to the plurality of remote terminals to form a plurality of remote terminal virtual playing fields. When the game server receives a request for a character action from the remote terminals, it alters the character's position on the game sever virtual playing field in response to the request. The remote terminal virtual playing fields are only updated when a request for a character action has been received from one of the remote terminals.

The above discussed preferred embodiment of the present invention provides a team-based interactive gaming system with chat rooms that entertainingly allows players to form teams over vast distances and communicate with their team members in real time. The customized teams and characters in the preferred embodiments enrich the gaming process and allow teams to distinguish themselves during league play that may follow an entire football, basketball, hockey or baseball season. In addition, frequent players are rewarded with experience points and improved character abilities that encourage them to continue playing the game. Thus, the above discussed embodiment is a substantial improvement upon the prior art.

Another embodiment of the present invention is directed toward a method of conducting an internet game that is managed by a central game server and played by a plurality of players viewing a game screen image at a plurality of remote terminals. The method includes the step of assigning a character to each player at a remote terminal. A plurality of characters are formed into at least two teams. A game is scheduled and players having characters on a team participating in the game are automatically informed of the game time and/or virtual location. A virtual playing field is created on the central server. A set of static data and initial character attribute data that is necessary for the remote terminal to display the game screen image to the players is then determined. The static data is data that will not change during the course of a game. The static data and initial character attribute data is stored on a remote terminal memory at each of the remote terminals. An initial game screen image having the player's characters in their initial state is displayed on the remote terminals based upon the static and initial character attribute data. Requests for changes in a character's attributes are received from the remote terminals with the game server. A set of dynamic data based on the received requests are determined such that the dynamic data specifies changes in the character's attributes. The dynamic data is then transmitted from the game server to the remote terminals. New game screen image data is calculated at the remote terminal based upon the stored static data and the received dynamic data. A new screen image is then displayed on the remote terminal based upon the new game screen image data.

Yet another embodiment of the present invention is directed toward an apparatus for implementing a game over a network. The apparatus includes a plurality of remote terminals for interfacing a plurality of players with the network. A game server manages the game and communicates with the plurality of remote terminals. The game server has a character attribute memory that stores character attribute data relating to a character associated with a player at a remote terminal. At least a portion of the character attribute data has been received from a player at a remote terminal. A team attribute memory stores team attribute data that relates to a selected team of characters. A chat room system provides a format for players to discuss the characters and game. Static information management software in the game server identifies static portions of the data required by the remote terminals to implement the game that will not change during the game. A remote terminal memory stores the static data at the remote terminal during the game. A portion of the static data stored in the remote terminals corresponds to the character attributes of players involved in the game. Experience software monitors the game play of a character and rewards experience points based upon the character's game play. The performance characteristics of the character are altered based upon the character's experience points.

While a number of embodiments have been described above, the embodiments are exemplary, not limiting, and it should be readily understood that the invention is susceptible to a variety of modifications and configurations. Therefore, having summarized various aspects of the invention in simplified form, the invention will now be described in greater detail with reference to the following figures wherein similar reference numerals designate similar features throughout the figures.

### BRIEF DESCRIPTION OF THE DRAWINGS

FIGS. 1(a-e) are a flow chart of a preferred embodiment of the present invention;

FIGS. 2(a and b) are a flowchart of a method of operating a gaming system in accordance with an embodiment of the present invention;

FIG. 3 is a flowchart of a network communication process in accordance with a preferred embodiment of the present invention; and

FIG. 4 is a block diagram of a network system for implementing an embodiment of the present invention.

### DETAILED DESCRIPTION OF THE INVENTION

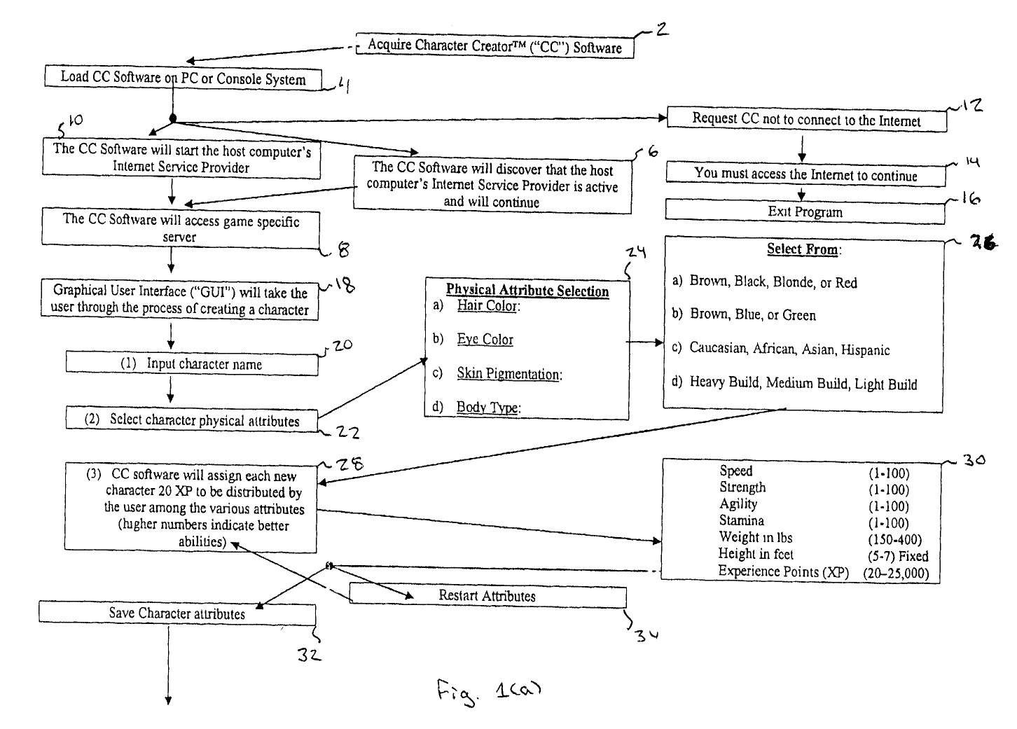

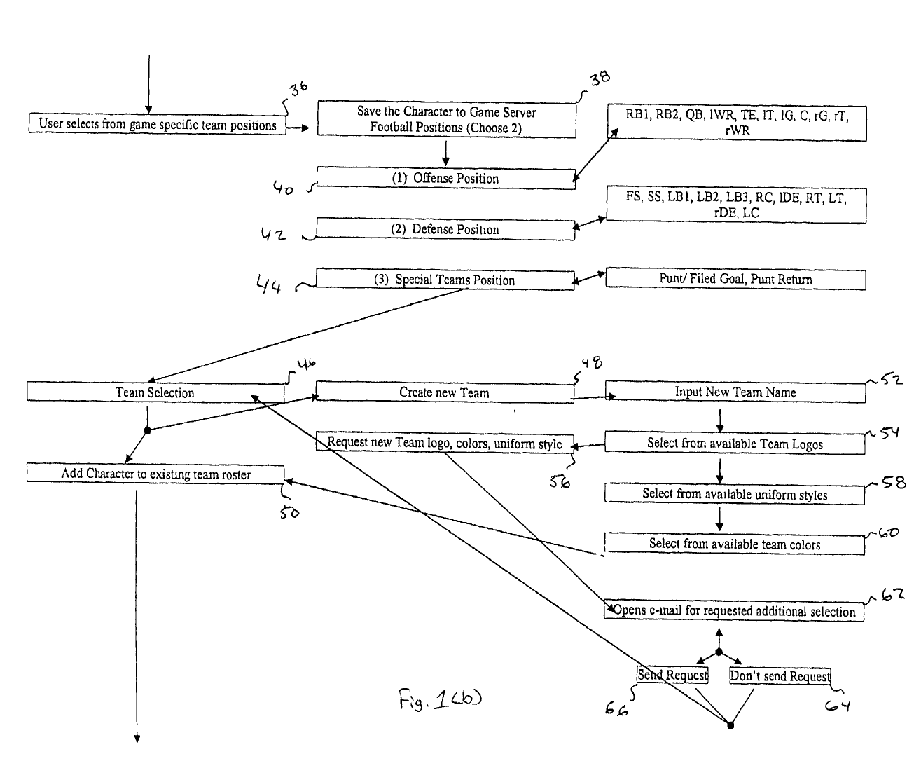

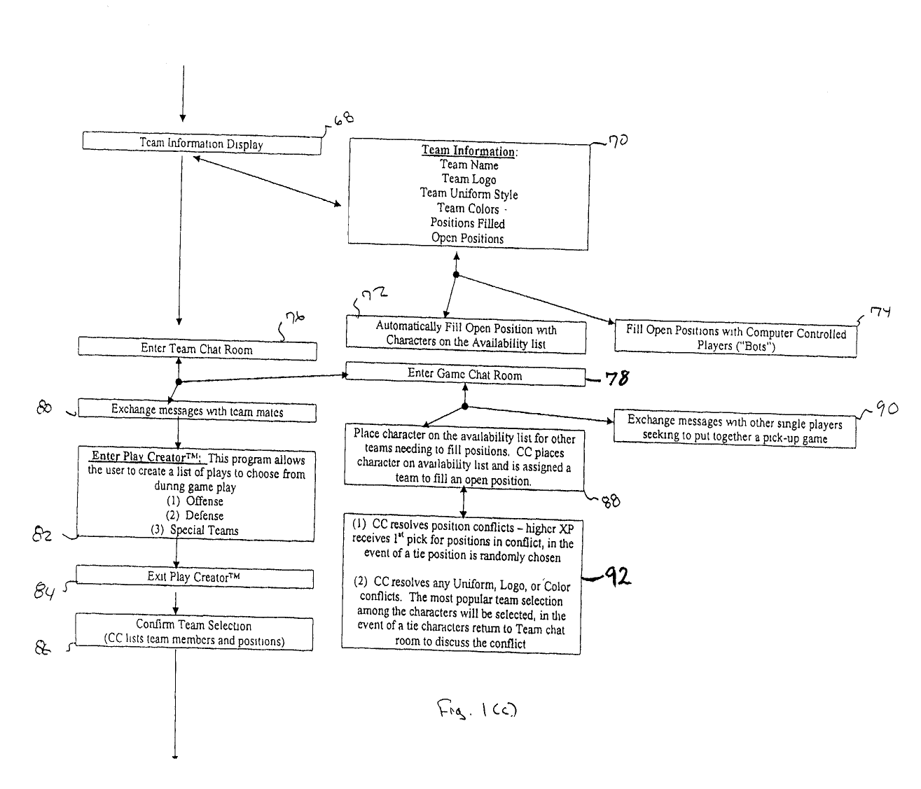

Referring now to FIGS. 1(a-e), a flow chart of a preferred embodiment of a method of playing a video game over the internet in accordance with the present invention is shown. The method commences with the acquiring of the gaming software from the internet or another source as shown in block 2. In a most preferred embodiment, the gaming software is the Character Creator™ (“CC”) software written by the present inventors. In block 4, this software is loaded into a personal computer or a gaming console system. Once the CC software is loaded into the computer, the software attempts to access the internet. If the software detects that the computer's internet service provider is active, as shown in block 6, the method proceeds to block 8 wherein the software accesses a game specific server. If the software senses that the internet service provider is not active, the method proceeds to block 10 wherein the software starts the host computer's internet service provider. The method then proceeds back to block 8. If the user instructs the software not to connect to the internet as shown in block 12, the method proceeds to block 14 wherein the user is informed that the internet must be accessed to continue. If the user refuses or is unable to access the internet, the method ends with the exiting of the program as shown in block 16

Once the software accesses the game specific server, the method proceeds to block 18 where a graphical user interface takes the user through the process of creating a character. The process of creating a character begins in block 20 with the inputting of a character name. In blocks 22, 24 and 26, the user is prompted to enter the desired physical attributes of the character. The attributes include the hair color, eye color, skin pigmentation and body type of the character to be selected. Once the character's physical attributes have been determined, the method proceeds to block 28 wherein 20 experience points are assigned to the character. In block 30, the user is allowed to assign these experience points to a variety of attributes that the video character will possess. These attributes may include, but are not limited to, speed, strength, agility, stamina and weight. Once the experience points have been assigned, the user is prompted to accept or reject the character attributes. If the user accepts the character attributes, the character attributes are saved as shown in block 32. If the user rejects the character attributes, the method proceeds to block 34 wherein the entry of the attributes is restarted by returning the method to block 28.

Once the character attributes have been saved, the method proceeds to block 36 where the user selects a position from a set of game specific positions. For example, in the context of football, the user is allowed to select three different categories of positions including an offense position, a defense position and a special teams position as set forth in blocks 40, 42 and 44. For each category, the user selects a player position such as quarterback, running back, wide receiver, etc. The character information is saved to the game server in block 38.

After selecting the character attributes, the user proceeds to a team selection step 46. The user then decides whether to create a new team, block 48, or to add the character to an existing team, block 50. If the user decides to create a new team, the method proceeds to block 52 wherein the user is prompted to input the new team name. In block 54, the user selects from a set of prepared team logos. The user also selects from available uniform styles, block 58, and team colors, block 60. Alternatively, the user can proceed to block 56 wherein the user may request a new team logo, color and uniform style. The method then proceeds to block 62 where an e-mail requesting the additional selections is produced. In blocks 64 and 66, the user is prompted to either send or not send the request. The method then proceeds back to block 46 and re-enters the team selection routine with the new team logos if requested. Users can e-mail custom team designs created with design software to the game server.

In block 68, the team information is displayed. The displayed team information preferably includes the team name, logo, uniform style and color as well as the positions on the team that have been filled and the positions that remain open as set forth in block 70. In blocks 72 and 74, the open positions are automatically filled with characters set up by other users that are on an availability list or by computer controlled players referred to as bots. Once all of the variables for the team have been determined, the software permits the characters on the team to enter a team chat room in block 76 or a game chat room in block 78. In the team chat room, the user can exchange messages with team mates as set forth in block 80. In block 82, the team chat room also provides the user access to a play creator to create a list of plays for use by the team during in the game. For example, in a football embodiment, the user would create a list of offensive, defensive and special teams plays for use in a future game. Once the list of plays is completed, the user exits the play creator, block 84, and confirms the team selection indicated by the computer, block 86.

In the game chat room, the user may place the character on an availability list as shown in block 88. Any conflicts between requested positions will resolved by the CC software. As shown in block 92, these conflicts are preferably resolved based upon the characters experience points. The CC software also resolves any conflicts that may arise with regard to uniforms, logos or colors selected for the team. The user may exchange messages with other players in the game chat room seeking to put together a pick-up game as shown in block 90.

Once the player and team attributes have been determined the method proceeds to block 94 where an opponent is chosen. The opponent may be selected by the game server from available confirmed teams as shown in block 96. Alternatively, in block 98, a team member may be allowed to select the opponent from a list of potential opponents on the server. A selection is also provided in block 100 for league play where the leagues are divided based upon the skill levels of the characters. After an opponent has been selected, the software prompts the user to either accept, block 102, or reject, block 104, the opponent. If the opponent is rejected, the method returns to block 94 wherein a new opponent is selected. Once the opponent has been selected, the method proceeds to block 106 where the quarterbacks for the opposing teams are prompted to agree upon a quarter length that determines the length of the game. Examples of possible quarter lengths are set forth in block 108 and confirmed by the user in block 110.

After the opponent has been selected, the game begins in block 112. As shown in block 114, the game is officiated by a computer generated referee. If a player exits the game during game play, a computer generated bot will assume the open position until the end of the next quarter at which point a new character can assume the position. The game ends after the conclusion of the fourth quarter in block 116. Experience points are then distributed to the characters that participated in the game in block 118. Although the points may be distributed in any fashion, in the embodiment of FIG. 1, each player of the winning team gets 100 experience points, block 120, and each player on the losing team gets 50 experience points, block 122. After the points are distributed, the players have the option of expending their experience points on increased character attributes, block 124, or saving the experience points for later use, block 126. The new player attributes and experience points are saved to the game server in block 128. The players are then given the option of returning to the game chat room to begin a new game, block 130, or ending the game, block 132.

The above discussed embodiment of the gaming system of the present invention provides an improved format for playing internet based team sports. The game server based set up allows the players to complete a realistic season's worth of games with a number of other players that would be too large to coordinate with prior gaming systems. The apportioning of experience points rewards those players that frequently use the system and creates an incentive to stick with a character once one is selected. In addition, the use of team chat rooms and game chat rooms allows the players on a team or in a game to discuss the game with their teammates as if they were in a locker room. Furthermore, the automatic entry and substitution of game controlled players allows players to enter and leave the game without interrupting the remaining players. This is especially important in an internet gaming system where twenty or more players may be involved in a single game and a season may consist of tens or hundreds or individual games.

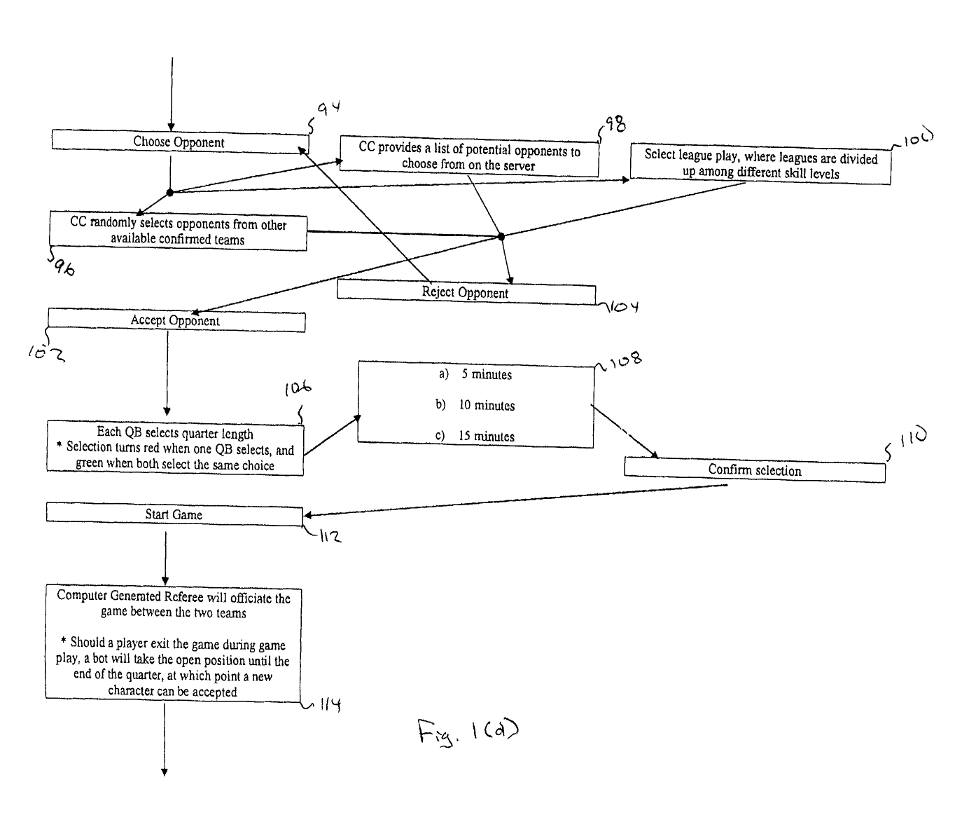

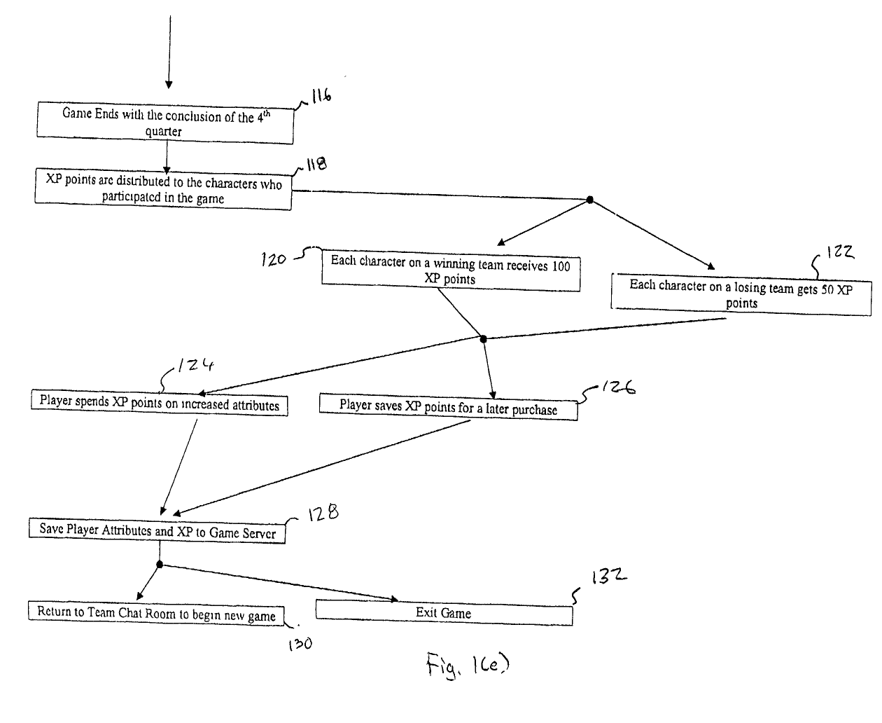

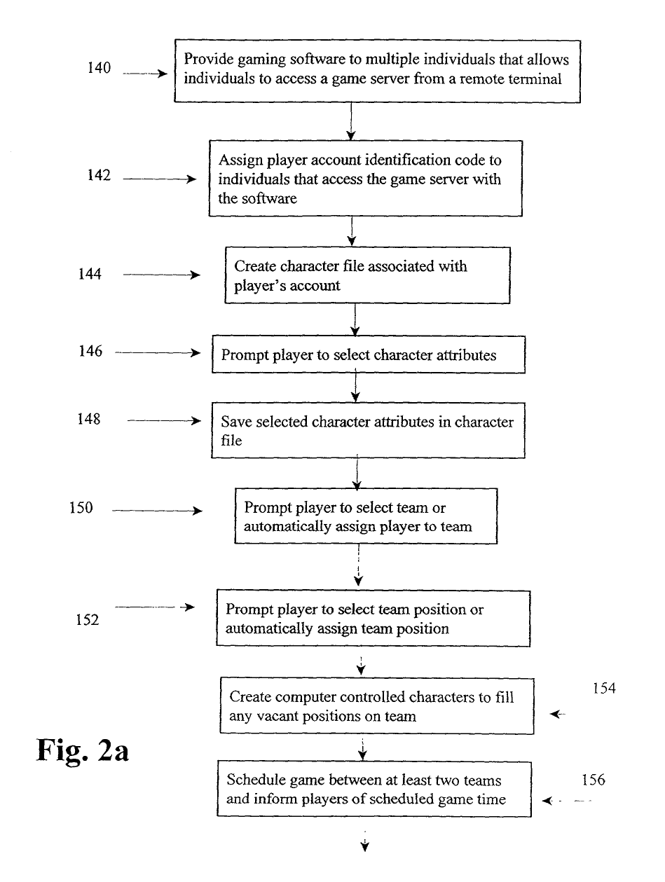

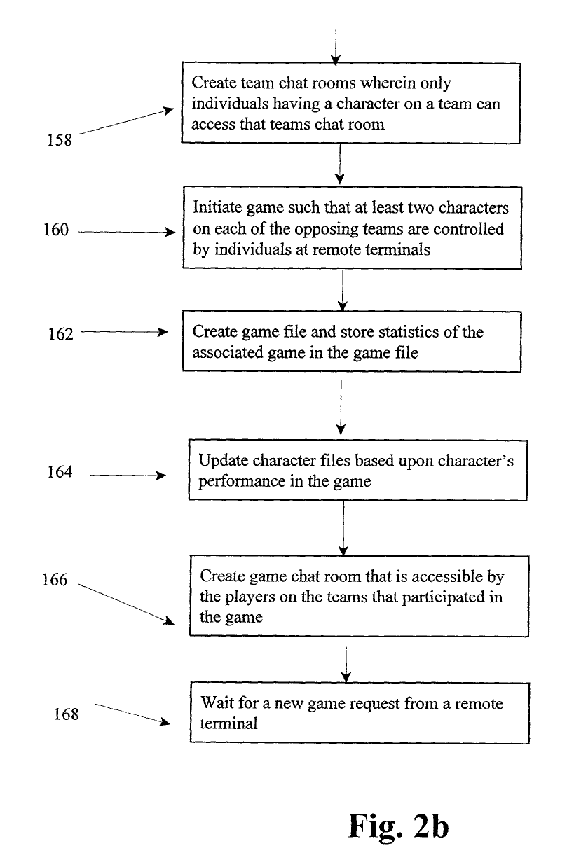

Referring now to FIG. 2(a), a flow chart of another embodiment of the present invention is shown. The method commences in block 140 with the providing of gaming software to multiple individuals that allows the individuals to access a game server from a remote terminal. When an individual accesses the game server with the software, block 142, the individual is assigned a player account identification code. The player's identification code identifies a memory storage location that is associated with the user. Once the individual has received their identification code, a character file that is associated with the player's account is created in block 144. This character file would contain information such as the physical attributes of the character, the experience of the character, the character's name, and the character's abilities. In block 146, the player is prompted to select a variety of character attributes from a list of attributes. The selected attributes are saved to the character file in block 148. As discussed in more detail below, saving the character attributes on the game server improves the flow of the game play by minimizing the amount of data that must be transferred between the remote terminals and the game server.

Once the character attributes have been determined, the method proceeds to block 150 where the player is prompted to select a team for his character to play on. Alternatively, the game server could be configured to automatically assign the new character to a team. After a team has been selected for the character, the player is prompted in block 152 to select a position for the character to play on the designated team. While the player preferably selects the character's position, in alternate embodiments, the selection of the character's position may be determined automatically by the game server. The game server will attempt to fill every character position on the team with a character controlled by a player at a remote terminal. However, if the game server is unable to fill every character position, the game server will create computer controlled characters to fill any vacant positions on the team as set forth in block 154.

In block 156, a game is scheduled between at least two teams of characters and the players that will be competing in the game are informed of the scheduled game time. Most preferably, the player's are notified by e-mail that a game is scheduled at a specified time. However, it will be readily appreciated that a variety of methods could be used to inform the players that a game was scheduled. A team chat room is created in block 158 as shown in FIG. 2(b). The team chat room allows all of the players on a team to communicate with one another to share their experiences and coordinate their strategy. In a most preferred embodiment, a small text area would also appear on the screens of all players on a team during game play such that only the players on the team could send and receive messages from other team members.

At the scheduled time, a game is initiated between two teams as set forth in block 160. Each team preferably has at least two characters that are controlled by individuals at remote terminals. However, the present invention could also be implemented such that one team was entirely controlled by the game server. When the game is over, a game file is created and the statistics of the game are stored in the associated game file in block 162. Storing the game statistics on the game server allows the players to monitor the progression of the various teams over a season. For example, an entire football season could be played by a league of teams created and stored on the game server. In step 164, the character files are updated based upon the character's performance in the game. This allows the players to keep track of their character's performance as well as that of other characters in the league. Awards may be given for performances such as the most valuable player for the game and the season. In addition, experience points are preferably awarded based upon the character's performance that allow the player to improve the character's abilities. For example, the player may receive 25 experience points that can be allocated to the character's various ability ratings such as speed, strength, agility and stamina. When the game is over, a game chat room is created in block 166 so that the players on the teams that participated in the game can discuss the game. After the game chat room has been created, the game server waits for a new game request from a remote terminal as shown in block 168.

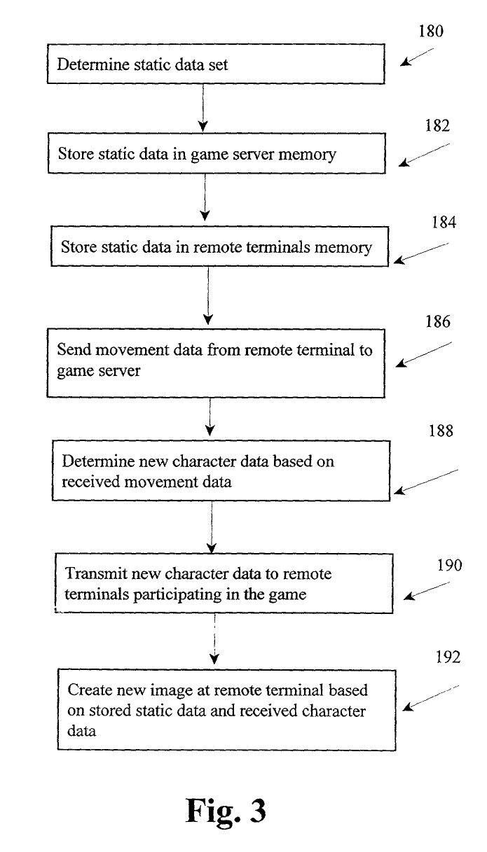

As briefly discussed above, preferred embodiments of the present invention utilize a method for transmitting information that minimizes the amount of information that needs to be transmitted from the game server to the remote terminals of the players. This network communication process is set forth in FIG. 3. The method commences with the game server determining a set of static data that will not change during the course of the game as shown in block 180. A preferred embodiment of the network communication process only transmits information when it is necessary to update data concerning a player's location or actions. This data preferably includes information such as the physical attributes of the computer character that affect the appearance of the character on the video screen. For example, the color of the characters jersey, hair, skin, their number, etc. Once this static data has been determined, it is stored in a memory that is accessible by the game server in block 182. It is also stored in a memory at the remote terminals of the players involved in the game in block 184. When a player at a remote terminal instructs their character to move, data relating to the current position and movement of the character is sent from the remote terminal to the game server as shown in block 186. The game server 202 then determines the character's new position based on the characters'last position and the movement and position data in block 188. Once this new positional data has been determined, the game server sends the positional data to all of the remote terminals having players involved in the game as shown in block 190. In block 192, the remote terminals use this positional and movement data in conjunction with the static and/or image data stored in their memory to create the moving image of the character displayed on their terminal. When the characters are not moving, the only data that is being transferred between the remote terminals and the game server is the overhead data needed to support the network connection. Transmitting information in this manner improves the network's performance and reduces latency. Thus, a preferred embodiment of the present invention improves the flow of the game play by minimizing the amount of static data transmitted between the remote terminals and game server. This is especially true when one remote terminal is using a slower network connection than the others.

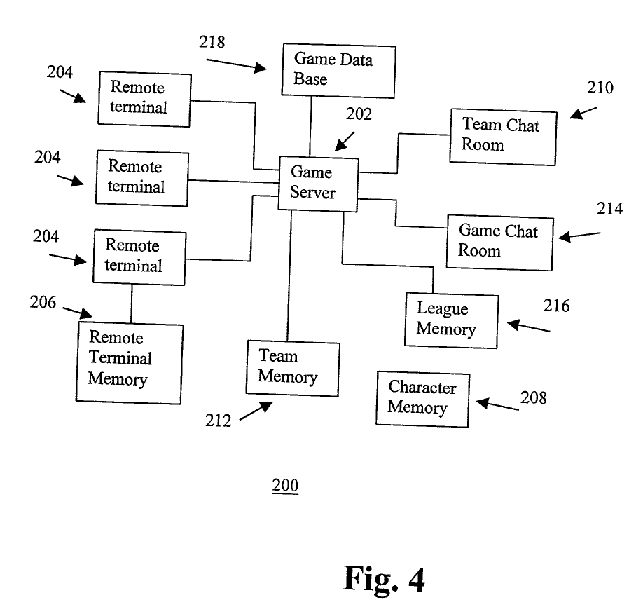

Referring now to FIG. 4, a block diagram of a network system for implementing a network gaming system 200 in accordance with an embodiment of the present invention is shown. The network gaming system 200 is implemented on a game server 202 and a plurality of remote terminals 204 that have a graphical user interface. The remote terminals 204 could be personal computers, wireless web devices or individual arcade playing stations. The game server 202 could be coupled to the remote terminals 204 through electrical wires, fiber optic cables, or wireless transmissions. Each remote terminal 204 is equipped with a remote terminal memory 206 that stores a customer software package that contains the programs for establishing data transmission between the remote terminals 204 and the game server 202. This software could be provided to a purchaser on a CD or similar type memory device or downloaded from the game server via a network system such as the internet. When the software is loaded onto a remote terminal 204, it asks the user if they would like to play a game. If the user answers yes, the software establishes a connection to the game server 202. The game server 202 then prompts the user to select the type of game they wish to play. For illustrative purposes, assume the user selects to play internet football.

When a user first logs on the game server 202, the server prompts the user to enter a number of selections for different character attributes. The user then selects the character attributes that they desire from the remote terminal 204. These attributes may include the height, weight, ethnicity, sex, uniform, player number, accessories, etc. of the character that the user wants to create. In addition, the user may be allowed to pick a character based upon an actual professional player on a professional team. Once the character attributes have been selected by the user, a portion of the character attributes are stored on the remote terminal memory 206 and the character attribute memory 208.

After selecting the character attributes, the user selects the team attributes for the team the character will play on. If a number of user controlled characters will be on the same team, a selection system is used to determine the parameters of the characters team. For instance, the users might vote upon the team, have a draft for teams or conduct a lottery. Access to teams may be limited based upon the player's identities, region or personal information. The users can also select the team's name, logo, colors, city, song, etc in a similar manner. Alternatively, the team parameters might be automatically assigned by the game server 202. Once the team parameters have been determined, they are stored in the team memory 212 that can be accessed by the game server 202. Once the teams have been selected, a team chat room 210 is formed that allows all of the members of one team to communicate with one another as if they were in a locker room or similar area.

After a number of characters have been established and teams formed, the game server 202 schedules a game between at least two teams of characters. The game server 202 informs the remote terminals 204 of the game time by e-mail, telephone or some other similar manner. At the designated time, the game is initiated by the game server 202. The game server 202 creates a central game data base 218 that contains the information needed to manage the game. The information stored in the game data base 218 specifies each player's location on the field and describes their motion at any given point in time. The information also specifies character's appearance and attributes. When a change in an attribute of a character is requested by a user at a remote terminal 204, the game server 202 receives the request and alters the character's attributes in the game data base 218 in the requested way. The game server 202 then communicates this change to the remote terminals 204. Preferably, the game server 202 does not merely update the character's positions at predetermined intervals. Instead, the game server 202 only sends information to the remote terminals 204 when a change in a character's motion or position is detected. Thus, certain static information that does not change during the course of the game is saved on the remote terminal memory 206 such that it does not have to be transmitted back and forth between the game server 202 and the remote terminal 204. For example, the static portion of the data used to create the image of the character on the remote terminal 204 is stored on the remote terminal memory 206 such that the new character image that results from the requested change in position is created based upon the received updated position data from the game server 202 and the stored static data in the remote terminal memory 206.

When a game has been completed, the players are allowed to discuss the game in a game chat room 214 that is maintained by the game server 202. The game chat room 214 also contains the statistics for the game in a menu driven format so that the players in the game chat room 214 can review their performance during the game. As discussed above, experience points that allow a player to upgrade a character's abilities may be awarded in the game chat room to the characters based upon their performance in the game. The results of the game are also stored in a league memory 216. In addition, the league memory 216 contains the statistics for all of the games that have been played by teams in a certain league. For example, if an entire season of football was played by a series of teams in a league, the league memory 216 would contain the rankings for the teams as well as their record and statistics for the season. As the season progresses, the league memory 216 is updated with the new information for the games and teams as the games are played.

In view of the above explanation of the particular features of the present invention, it will be readily appreciated by one skilled in the art that the present invention can be usefully employed in a wide variety of embodiments. While certain embodiments have been disclosed and discussed above, the embodiments are intended to be exemplary only and not limiting of the present invention. The appropriate scope of the invention is defined by the claims set forth below.

I claim:

1. A method of conducting a network gaming system that utilizes a plurality of remote terminals coupled to a game server, said method comprising:
assigning an identification code to each of a plurality of players wherein each player is uniquely identified by their corresponding identification code;
receiving identification codes with the game server from players at the remote terminals and verifying that the received identification codes correspond to authorized identification codes;
prompting the authorized players at the remote terminals to create characters associated with the players by selecting a set of character attributes for each character;
forming groups of player created characters into teams;
scheduling games between the teams of player created characters;
conducting the scheduled games; and
storing the results of the games on the game server.

2. The method of claim 1 further comprising forming a plurality of team chat rooms that are accessible from the remote terminals wherein each team chat room is associated with a particular team such that characters on a particular team can have a discussion with other characters on the team.

3. The method of claim 1 further comprising forming a game chat room such that all players that have a character in a game can discuss the game.

4. The method of claim 1 wherein the set of character attributes includes at least one of the character's speed, strength, agility, stamina, weight and height.

5. The method of claim 1 wherein the set of character attributes includes at least one of the character's eye color, hair color, ethnicity and body type.

6. The method of claim 1 further comprising prompting players on a team to select a set of team attributes.

7. The method of claim 6 wherein the team attributes include at least one of a team name, team logo, team color or team uniform.

8. The method of claim 1 wherein the step of conducting the scheduled games further comprises:
establishing a set of data that represents a game server virtual playing field on the game server;
positioning the characters on the game server virtual playing field;
downloading the game server virtual playing field data to the plurality of remote terminals to form a plurality of remote terminal virtual playing fields;
receiving requests for character actions from the remote terminals;
altering the character's position on the game sever virtual playing field in response to the requests; and
updating the remote terminal virtual playing fields only when a request for a character action has been received from one of the remote terminals.

9. A method of conducting an internet video game managed by a central game server and played by a plurality of players viewing a game screen image at a plurality of remote terminals, said method comprising:
assigning a character to each player at a remote terminal;
forming a plurality of characters into at least two teams;
creating a virtual playing field on central server;
determining a set of static data and initial character attribute data that is necessary for the remote terminal to display the game screen image to the players wherein the static data will not change during the course of a game and saving the static data and initial character attribute data on a remote terminal memory at each of the remote terminals;
displaying an initial game screen image having the player's characters in their initial state on the remote terminals based upon the static and initial character attribute data;
receiving requests for changes in a character's attributes from the remote terminals with the game server;
determining a set of dynamic data based on the received requests wherein the dynamic data specifies changes in the character's attributes;
transmitting the dynamic data to the remote terminals;
calculating new game screen image data at the remote terminal based upon the stored static data and the received dynamic data;
and displaying a new screen image on the remote terminal based upon the new game screen image data.

10. The method of claim 9 further comprising establishing a team chat room on the game server such that players having characters on the same team can discuss issues concerning their team.

11. The method of claim 9 wherein the step of assigning a character to each player further comprises allowing a player to select attributes of the character.

12. The method of claim 9 wherein the step of forming at least two teams further comprises allowing the players to select the team on which they wish to play.

13. The method of claim 9 wherein the step of forming two teams further comprises allowing the players to select the team attributes of their team.

14. The method of claim 9 further comprising the step of scheduling a game and automatically informing players having characters on a team participating in the game of the game time and/or virtual location.

15. An apparatus for implementing a game over a network, said apparatus comprising:
a plurality of remote terminals for interfacing a plurality of players with the network;
a game server for managing the game and communicating with the plurality of remote terminals wherein the game server comprises:
a character attribute memory for storing character attribute data relating to a character associated with a player at a remote terminal wherein at least a portion of the character attribute data has been received from a player at a remote terminal;
a team attribute memory for storing team attribute data relating to a selected team of characters; and
a chat room system for providing a format for players to discuss the characters and game.

16. The apparatus of claim 15 further comprising static information management software in the game server that identifies static portions of the data required by the remote terminals to implement the game that will not change during the game and a remote terminal memory for storing the static data at the remote terminal during the game.

17. The apparatus of claim 16 where in a portion of the static data stored in the remote terminals corresponds to the character attributes of players involved in the game.

18. The apparatus of claim 17 further comprising experience software for monitoring the game play of a character and rewarding experience points based upon the character's game play.

19. The apparatus of claim 18 further comprising software for altering the performance characteristics of the character based upon the character's experience points.

20. The apparatus of claim 15 further comprising a player database for allowing players to select a famous sports personality as their character and a famous team as their team.
